(19) United States
(12) Patent Application Publication
(10) Pub. No.: US 2020/0016522 A1
(43) Pub. Date: Jan. 16, 2020

(54) Centrifugal Mesh Mist Eliminator

(71) Applicant: McKendree G. Pepper, Beaumont, TX (US)

(72) Inventor: McKendree G. Pepper, Beaumont, TX (US)

(21) Appl. No.: 16/504,377

(22) Filed: Jul. 8, 2019

Related U.S. Application Data
(60) Provisional application No. 62/698,311, filed on Jul. 16, 2018.

(51) Int. Cl. B01D 45/02; F25B 43/02; B01D 39/12; B01D 1/30

(52) U.S. Cl. CPC B01D 45/02; F25B 43/02; F25B 2400/02; B01D 1/305; B01D 39/12

(57) ABSTRACT

A centrifugal mesh mist eliminator generally comprises a cylindrical roll of mesh attached to a vertical rotating shaft positioned within the center of a pressure vessel. A horizontal partition within the pressure vessel forms a barrier seal between the upper and lower portions thereby directing droplet laden gas flow through the rotating mesh. The incoming droplet laden gas stream enters the lower portion of the pressure vessel through an inlet nozzle. The droplet laden gas stream flows through the rotating cylindrical mesh element where it enters the top section of the pressure vessel. Droplets impinge on the mesh and coalesce into larger diameter drops. These larger diameter drops detach from the mesh due to centrifugal force. The detached liquid droplets settle to the bottom of the vessel as their mass is sufficient to overcome the surrounding flow stream drag force. Liquid discharges from the bottom of the vessel through an outlet nozzle while dry gas exits through a top outlet nozzle.

### CROSS REFERENCE TO RELATED APPLICATIONS

Priority is claimed from U.S. Provisional Application No. 62/698,311 filed on Jul. 16, 2019 and incorporated herein by reference in its entirety.

### STATEMENT REGARDING FEDERALLY SPONSORED RESEARCH OF DEVELOPMENT

Not Applicable.

### NAMES TO THE PARTIES TO A JOINT RESEARCH AGREEMENT

Not Applicable.

### BACKGROUND

This disclosure is related to the field of mist elimination technology, used in the removal of entrained liquid droplets from gas streams such as required in oil and gas production, petroleum refining, and chemical process industries. Various applications include improved emission control, product recovery, corrosion protection, erosion control, and improvement in product purity.

Conventional industrial mist eliminators use a fixed (static) wire mesh supported within a process vessel. In this configuration, droplet laden process gas flow is directed through the static wire mesh element. Droplets impact with and coalesce on the wire mesh material surface. These mist eliminators utilize gravitational force imposed on the coalescing droplets to detach them, thereby separating the entrained droplets (mist) from the process gas. U.S. Pat. No. 3,997,303 issued to Newton and U.S. Pat. No. 5,985,004 issued to Boyd describe mist eliminators that use static wire mesh elements positioned within a pressure vessel whereby gravitational force serves to separate coalescing droplets from the mesh.

Another means used to provide separation of droplet laden streams is a cyclone separator. Cyclone separators rely on rotational effects and gravity to separate droplets from a gas stream. Cyclone separators are frequently used in applications where the entrained particle size is over 5 μm in diameter. U.S. Pat. No. 6,251,168 issued to Birmingham et al. shows using a combination of a high efficiency cyclone with coalescing media to enhance separation efficiency.

Centrifugal separation is also used to remove droplets from gas streams. U.S. Pat. No. 7,396,373 issued to Lagerstedt et al. discloses a rotor with sedimentation members rotatably mounted in a stationary housing to separate droplets entrained in flowing process gas. Droplet laden gas enters the device through a central inlet. The droplet laden gas then flows through rotating vanes of the sedimentation members. The droplets deposit on the sedimentation members and are then transferred by means of centrifugal force to the inner surface of the separator outer stationary housing. Cleaned gas leaves the separator outlet while liquid droplets flow downward following guide rails of the outer stationary housing wall. A gas vortex generated by the rotating sedimentation members forces the liquid droplets to flow along the stationary housing guide rails until they discharge through the liquid outlet. This technology is primarily applied in the metalworking industry relative to CNC machining rather than general, large-scale, process applications.

A centrifugal filtration device utilizing microporous membrane filter media is described in U.S. Pat. No. 6,517,612 issued to Crouch et al. The disclosed device receives a particle laden gas stream that flows into a plenum chamber surrounding a rotating filter element. As gas flows through the centrifugal filtration device, the filter element rotates at sufficient speed to eject particles from the filter media. Microporous membranes are continuous sheets of material that have a pore volume of 50% or more, with 50% or more of the pores having nominal diameters of about 5 μm or less. Devices with this pore structure are not generally suited for large-scale industrial processes having high liquid loading and large gas flow rates.

### SUMMARY

A purpose of a mist eliminator according to the present disclosure is to improve the efficiency of mist elimination equipment which is known to rely primarily on gravitational force as the means to detach coalescing droplets from internal mesh material. The present mist eliminator imparts centrifugal force on the mesh by directing droplet laden gas flow through a vertical cylindrical mesh pad mounted on a rotating central shaft. The capability of controlling angular velocity of the mesh pad, and hence the centrifugal force acting on the droplets detaching from the mesh material, introduces added control over equipment operating parameters. For example, the variation of centrifugal force on droplets detaching from mist eliminator mesh can serve to reduce re-entrainment and carryover of droplets experienced by conventional mist elimination equipment that relies on gravitational force. Under high gas flow rates, this device extends the equipment operating flow range by improving droplet detachment from the mist eliminator mesh where gravity alone has limited effect in imparting sufficient force to overcome the surrounding gas stream drag force.

A mist eliminator according to the present disclosure may provide an added benefit of improved cleaning capability in services where entrained liquid drops foul the mesh material. The combination of centrifugal force acting on the rotating mesh can improve backwashing where the mere application of sprays to static mesh material has shown limited effectiveness.

Mist eliminators known in the art comprise static wire mesh pads and rely on gravitational force to detach coalescing droplets from the mesh surface. As process conditions change, static mesh mist eliminator efficiency is limited due to the fixed value of gravitational force.

A mist eliminator according to the present disclosure may provide a means for reducing re-entrainment of coalescing droplets in a mist-containing gas stream as they detach from mist eliminator mesh. A mist eliminator according to the present disclosure may be used in applications where high gas flow rates exist and low pressure drop is a concern. Increased centrifugal force may be imposed on the droplets by changing a rotation speed of the mesh to improve the removal of detaching droplets from the mesh as the gas flow rate increases through the eliminator.

A separator (pressure) vessel in which a rotatable mesh mist eliminator element is contained may comprise a partition, which divides the separator vessel into two portions. The lower portion may serve as a plenum through which droplet laden gas enters. As the droplet laden gas passes through the rotating mesh mist eliminator element, droplets coalesce on the mesh and detach at least in part due to centrifugal force generated by the rotating mesh element. The detached droplets have a greater mass than the incoming entrained droplets entrained in the gas stream. This additional mass enables the droplets to overcome the surrounding gas stream drag force within the lower portion. The droplets then settle to the bottom of the separator vessel where liquid accumulates and may be discharged through a bottom outlet.

The mesh mist eliminator element generally comprises a cylindrically shaped roll of mesh attached to a support structure, which is itself affixed to a rotating shaft that extends vertically through the separator vessel. The bottom end of the mesh mist eliminator element may comprise an annular disk with inside diameter matching the outside diameter of the rotating shaft. In this manner. The lower annular disk of the mist eliminator element provides support, combined with sealing area to ensure the droplet laden gas only enters through the sides of the cylindrical mesh wall. The top of the rotating mist eliminator element resides within the partition separating the separator vessel into upper and lower sections. The contacting surfaces of the rotating mesh element and the partition may be supported using a rotating bearing, rotating seal, or a combination thereof.

### BRIEF DESCRIPTION OF THE DRAWINGS

FIG. 1 is a cross-sectional view of a pressure vessel according to the present disclosure.

FIG. 2 is a detailed view of the rotating mesh coalescing element contained within the pressure vessel shown in FIG. 1.

FIG. 3 is a detailed view of the rotating mesh coalescing element shown in FIG. 2 combined with a backwash spray element through the top opening of the rotating mesh cylinder.

FIG. 4 is a top end view of the device shown in FIG. 3 when viewed along lines 3-3′.

FIG. 5 is a cross-sectional view of the device shown in FIG. 3 when viewed along lines 4-4′.

FIG. 6 is a bottom end view of the device shown in FIG. 3 when viewed along lines 5-5′.

FIG. 7 is a top end view of the device shown in FIG. 3 when viewed along lines 3-3′.

FIG. 8 is a cross-sectional view of the device shown in FIG. 3 when viewed along lines 4-4′.

### DETAILED DESCRIPTION

As a general description of a mist eliminator according to the present disclosure, the mist eliminator comprises a rotating mesh coalescing (mist elimination) element attached to a rotating central shaft. The rotating central shaft may be driven by a motor. Liquid droplets entrained in a gaseous stream aggregate into larger liquid droplets as they impinge on the rotating mesh coalescing element, while the gas flows through the rotating mesh coalescing element. The aggregating liquid droplets migrate through the rotating mesh coalescing element radially outwardly toward the outer periphery of the rotating mesh element where they detach from the mesh coalescing element. During use of the mist eliminator, the detaching droplets are outwardly ejected from the outer periphery of the rotating mesh coalescing element, possessing sufficient mass to overcome the surrounding flowing gas drag force and thereby disengaging from the surrounding flowing gaseous stream.

The rotating central shaft may comprise an upper seal, e.g., a stuffing box, surrounding the rotating central shaft at the top of a separator vessel through which the central shaft passes. The central shaft may comprise a lower bearing arranged near the bottom of the separator vessel to enable rotation of the central shaft while reducing friction and handling stress experienced by the rotating central shaft.

The separator vessel comprises an inner partition dividing the separator vessel into an upper section and a lower section. The partition comprises a rotating seal, or a plurality of rotating seals, or a bearing, or a plurality of bearings, or a combined rotating seal and bearing, or a plurality of combined rotating seals and bearings, or a sealed bearing, or a plurality of sealed bearings. The foregoing may provide a sealing contact surface between the static surface of the partition and a rotating surface of the eliminator element. The lower section comprises an inlet through which the incoming gas-liquid stream comprising entrained liquid droplets enters the separator vessel. The gas may then be deflected by a deflector baffle. The upper section receives separated gas exiting the top opening of the mesh eliminator element. Separated gas exits the separator vessel through a top outlet. Liquid exits the separator vessel through an outlet.

In some embodiments, the rotation speed of the mesh eliminator element may be adjusted to correspond to changes in gas flow rate and/or liquid loading, thereby to maintain separation of the mist from the gas notwithstanding changes in gas flow rate and/or liquid loading.

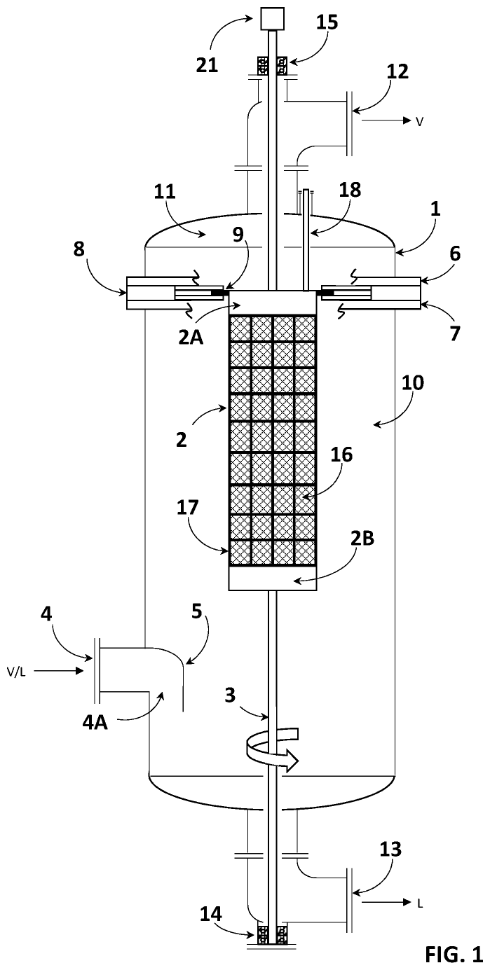

FIG. 1 is a schematic diagram of an example embodiment of a centrifugal mesh mist eliminator according to the present disclosure. A separator vessel 1 contains a rotatable mesh mist elimination element 2 that is connected to a rotatable shaft 3. The shaft 3 may be rotatably supported within the separator vessel 1. A two-phase gas stream, comprising gas with entrained liquid droplets, enters from an outside source through an inlet 4 passing through the wall of the separator vessel 1. The inlet 4 may comprise a nozzle 4A to direct and/or change velocity in the inflowing gas-liquid stream. The gas-liquid stream may, in some embodiments, be diverted away from the mist elimination element 2 by an inlet baffle 5. In some embodiments, diversion of the inlet gas-liquid stream may be performed by orienting the inlet nozzle 4 tangential to the separator vessel 1.

The separator vessel 1 comprises a top section 6 and a bottom section 7. The top 6 and bottom 7 sections of the separator vessel 1 operate under a differential pressure due to the pressure drop across the mesh mist elimination element 2. The top 6 and bottom 7 sections in the present embodiment may be separated by a partitioning flange 8 and a rotary seal 9 secured to the partitioning flange 8. In some embodiments the contacting surface between the mesh mist elimination element 2 and the partitioning flange 8 comprises a bearing, a plurality of bearings, a seal or a plurality of seals, a sealed bearing or a plurality of sealed bearings, or a combination of a bearing and a seal, or a plurality of combined bearings and seals. By providing a sealed contact between the partition 8 and the mesh mist eliminator element 2, the top portion 6 and the bottom portion 7 are pressure isolated other than through the mesh mist eliminator element 2. Gas thus flows through the separator vessel 1 from a region of higher pressure 10 to a region of lower pressure 11 by passing through the mesh mist elimination element 2. Liquid droplets that contact and coalesce on the mesh mist elimination element 2 are detached by the centrifugal force imposed by continually rotating the mist elimination element 2. The detached liquid droplets are larger than the droplets entrained in the inlet two phase gas stream. The detached droplets may be either deflected to the interior of the wall of the separator vessel 1, where they drop down the vessel wall to collect with liquid in the bottom of the separator vessel 1, or they settle out of the gas stream due to their greater mass, which permits them to overcome the surrounding gas flow drag forces experienced within the lower section 7 of the separator vessel 1 and drop to the bottom of the separator vessel 1. Filtered (mist-stripped) gas leaves the mist elimination element 2 through the center top opening of the mist elimination element 2, where it enters the top section 6 of the separator vessel 1. Filtered gas then discharges from the separator vessel 1 through an outlet 12 at the top of the separator vessel 1. Liquid discharges from the bottom of the separator vessel 1 through a bottom outlet 13. The rotatable shaft 3 may be supported at the bottom by a foot bearing 14 and at the top by a seal and bearing combination 15. The shaft 3 may be rotated by a motor 21 connected to the shaft 3.

In some embodiments, rotation speed of the motor 21 may be adjusted to correspond to the rate of flow of gas into the separator vessel 1. By adjusting the rotation rate of the motor, increased flow of droplet laden gas may be processed by the mist eliminator to maintain substantially full separation of mist from the gas.

The rotating mesh mist eliminator element 2 comprises a mist eliminator mesh material 16 which may be shaped in the form of a cylinder and affixed to an outer reinforcement element 17, such as a frame. The reinforcement element 17 maintains the shape of the mesh material 16 so that gas can flow therethrough and into the interior of the mist eliminator element 2 for discharge through the outlet 12. The rotating mesh mist eliminator element 2 may comprise an upper disk 2A proximate one longitudinal end shaped in the form of an annular ring so as to engage the rotary seal 9. The upper disk 2A enables passage of gas through the rotating mesh mist eliminator element 2 to the top section 6. The rotating mesh mist eliminator element 2 may comprise a lower disk 2B in the form of a solid plate proximate the other longitudinal end of the rotating mesh mist eliminator element 2. The lower disk 2B stops movement of any fluid through the longitudinal end of the rotating mesh mist eliminator element 2.

In some embodiments, an internal spray bar or a plurality of internal spray bars 18 may be positioned vertically within the mesh mist eliminator element 2 to permit backwashing when the mist eliminator is used in fouling process services. The spray bar(s) 18 may comprise spray nozzles 18A along the length of the spray bar 18 to enable spraying water or other cleaning liquid to facilitate cleaning the mesh material 16.

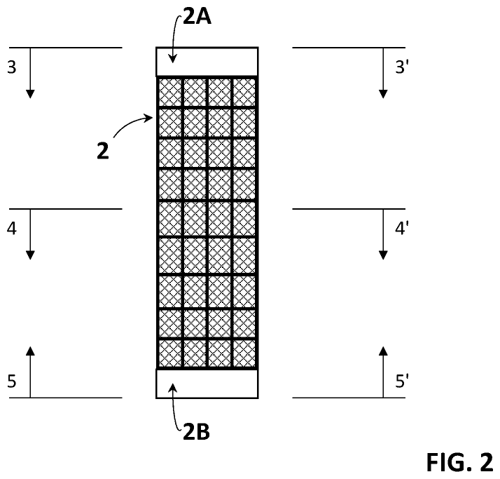

FIG. 2 is a view of the mesh elimination element contained within the pressure vessel shown in FIG. 1.

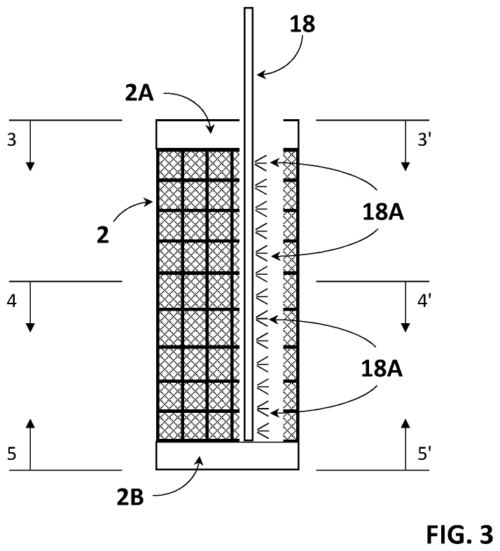

FIG. 3 is a view of the mist elimination element shown in FIG. 2 combined with a backwash spray element extending through the top opening of the mist elimination element.

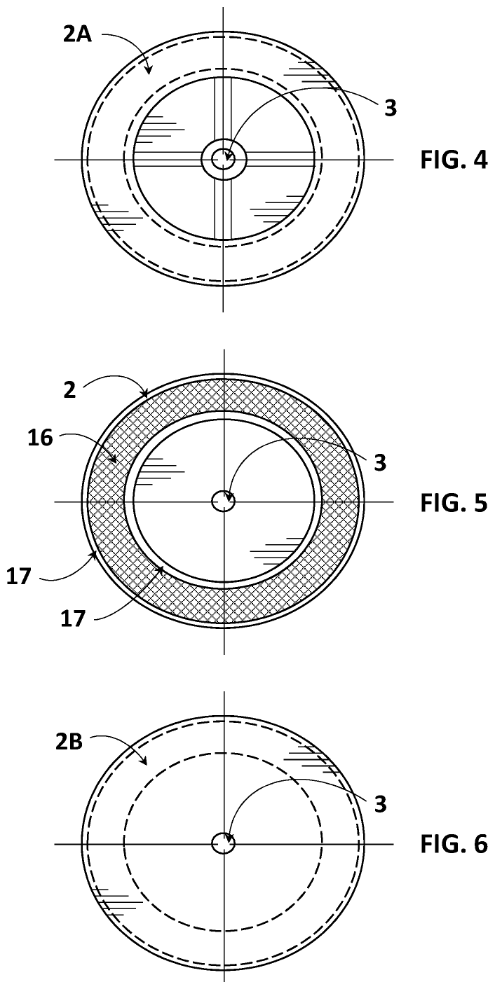

FIG. 4 is a top end view of the mesh mist elimination element 2 shown in FIG. 3. The top of the rotating mesh elimination element 2 may be open, such as in the form of an open frame or the upper disk 2A described above, to enable flow of mist-stripped gas through the top of the mesh mist elimination element 2, and at the same time form a pressure-tight seal to the partition (8 in FIG. 1) so that all gas entering the separator vessel (1 in FIG. 1) is constrained to flow through the mesh mist elimination element 2.

FIG. 5 is a cross-sectional view of the mesh mist elimination element 2 shown in FIG. 3 illustrating one section of the mist eliminator mesh material 16 affixed to the outer reinforcement element 17.

FIG. 6 is a bottom end view of the mesh mist elimination element 2 shown in FIG. 3. The bottom of the mesh mist elimination element 2 may be closed to flow of gas by the lower disk 2B so that all gas entering the separator vessel (1 in FIG. 1) is constrained to flow through the mesh mist elimination element 2.

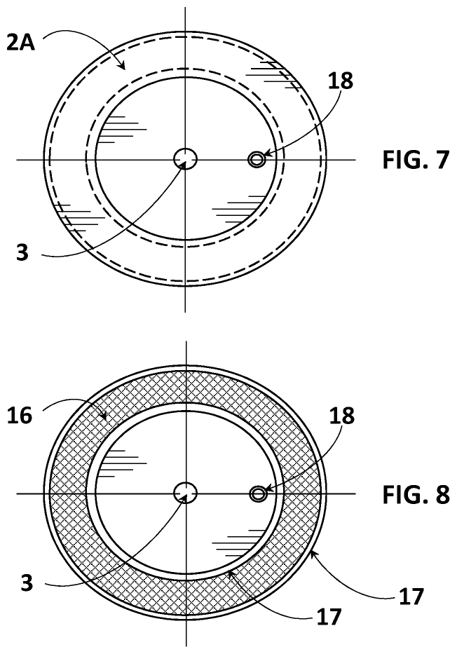

FIG. 7 is a top end view of the device shown in FIG. 3 when viewed along lines 3-3′.

FIG. 8 is a cross-sectional view of the device shown in FIG. 3 when viewed along lines 4-4′.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. An apparatus for extracting entrained liquid droplets from a gaseous stream, comprising:
a mesh mist elimination element attached to a frame;
the frame affixed to a shaft, the shaft rotatable mounted in a separator vessel;
wherein the shaft, the frame and the mesh mist eliminator element are disposed in the separator vessel, the separator vessel comprising a fluid inlet on one side of a partition disposed in the separator vessel, the separator vessel comprising a fluid outlet on the other side of the partition, the partition in rotatable sealing contact with an exterior of the mesh mist eliminator element; and
a motor coupled to the shaft to rotate the shaft and the mesh mist eliminator element.

2. The apparatus of claim 1 further comprising at least one backwashing spray disposed inside the mesh mist eliminator element.

3. A method for extracting entrained liquid droplets from a gaseous stream, comprising:
moving the gas stream through a mesh mist elimination element from an exterior of the mesh mist elimination element to an interior thereof;
rotating the mesh mist elimination element; and
collecting coalesced droplets of the entrained liquid on an interior wall of a separator vessel in which the mesh mist elimination element is disposed.

4. The method of claim 3 further comprising changing a rate of rotating the mesh mist eliminator element correspondingly to a flow rate of the gaseous stream through the mesh mist eliminator element.
